(19) United States
(12) Patent Application Publication
(10) Pub. No.: US 2026/0180999 A1
(43) Pub. Date: Jun. 25, 2026

(54) ARTIFICIAL INTELLIGENCE (AI) THREAT DETECTION AND MITIGATION IN COMPUTING AND NETWORKING ENVIRONMENTS

(71) Applicant: Arctic Wolf Networks, Inc., Eden Prairie, MN (US)

(72) Inventors: Daniel Salvatore Schiappa, Windermere, FL (US); Michael Elliott Mylrea, Delray Beach, FL (US); Kenneth D. Ray, Enumclaw, WA (US); Madeline Angelina Chantry, Celebration, FL (US)

(21) Appl. No.: 19/423,158

(22) Filed: Dec. 17, 2025

Related U.S. Application Data
(60) Provisional application No. 63/736,401, filed on Dec. 19, 2024.

(51) Int. Cl. H04L 9/40

(52) U.S. Cl. CPC H04L 63/1416; H04L 63/1441

(57) ABSTRACT

Disclosed are techniques for monitoring artificial intelligence (AI) and responding to cybersecurity threats in a computing environment. A method can include monitoring computational resources and network traffic to identify potential AI operations, determining AI-specific behavioral patterns based on applying heuristics to the AI operations, identifying deviations of the AI operations from normal operational patterns using deep learning anomaly detection techniques, and returning information about the identified deviations of the AI operations. The method can include generating cloned copies of workloads from a cloud computing environment, detecting AI operations based on the cloned copies, and identifying deviations of the detected AI operations from normal operational patterns using deep learning anomaly detection techniques. The method can include concurrently monitoring hardware, middleware, and software layers of an AI system to identify potential AI operations and performing if/then processing to identify anomalies.

### INCORPORATION BY REFERENCE

This application claims the benefit of priority of U.S. Provisional Patent Application No. 63/736,401, filed Dec. 19, 2024, the entirety of which is incorporated herein by reference.

### TECHNICAL FIELD

This disclosure generally describes devices, systems, and methods related to identifying, detecting, and mitigating risks associated with unknown artificial intelligence (AI) workloads or other workloads running within computing and/or networking systems.

### BACKGROUND

As AI technologies evolve and proliferate across various industries, enterprises face growing threats from malicious actors that may seek to exploit vulnerabilities in AI systems. For example, organizations increasingly deploy AI models, which increases a risk of unauthorized or shadow AI instances to operate within networks. These shadow instances may pose threats including but not limited to unauthorized data access and processing, resource misappropriation, potential vectors for adversarial attacks, compliance violations, and/or undocumented business costs

### SUMMARY

The disclosure generally describes technology for identifying, detecting, and mitigating threats, vulnerabilities, and associated risks in artificial intelligence (AI) systems deployed within enterprises. The disclosed technology provides a combination of processes in AI system usage fingerprinting, integrity enumeration, anomaly detection, and threat intelligence integration to enhance security and resilience of the AI systems. The disclosed technology therefore fills a critical gap in mitigating risks posed by inadvertent AI-related data loss, adversarial attacks, model vulnerabilities, supply chain compromises, or other types of risks. Existing cybersecurity solutions lack the ability to effectively detect and mitigate threats, vulnerabilities, and associated risks of AI algorithms, models, and platforms. For example, known solutions focus on traditional threat detection, lacking the specialized capabilities required to identify and analyze AI-specific behaviors and risks. Traditional intrusion detection systems (IDS) and security information and event management (SIEM) solutions, for example, are not designed to recognize the unique computational patterns, resource utilization profiles, and network behaviors associated with AI models in operation. The disclosed technology, therefore, provides a technical solution for providing real-time threat intelligence, anomaly detection, and proactive risk mitigation that is tailored to the specific characteristics of AI systems.

Additionally, enterprises may not be able to effectively identify what AI is being used and its security and integrity throughout its design and deployment lifecycle. Exacerbating the problem, for an increasing number of enterprises, AI is integral to their revenue generation plans. Thus, these enterprises can have material risk that is not being monitored, which puts the enterprises at risk of various compliance violations. The disclosed technology can help fill these gaps by detecting unauthorized or shadow AI activities running within an enterprise's infrastructure. The disclosed technology can leverage a multi-layered approach to monitor and correlate system signatures, heuristic patterns, and behavior across the entire technology stack, including hardware, middleware, software layers, and user behavior analytics that weave in between. The system can incorporate a correlation engine powered by AI and large language models (LLMs) to process if/then logical statements that determine whether an unauthorized AI process is active, thereby enabling real-time detection and response. The disclosed technology can therefore provide a technical solution for detecting unauthorized or shadow AI processes that can drain resources, violate compliance regulations, and introduce security risks. Traditional monitoring systems may not detect AI processes running on unsanctioned hardware or environments since the traditional systems cannot identify behaviors and patterns associated with complex AI workloads. The disclosed technology, on the other hand, closes that gap by using a multi-layered, AI-driven system that automatically identifies and mitigates shadow AI activities across the entire AI technology stack.

Similarly, the disclosed technology can provide an agentless solution for detecting unauthorized or shadow AI instances in cloud environments. In this context, “agent” can include a small piece of software that can be installed on compute devices and configured to monitor for threats and check for security risks. The disclosed technology can also be deployed at other endpoint devices and/or system (e.g., direct user interaction and execution, laptops, mobile phones) and/or on cloud workloads (e.g., with or without users). As cloud adoption increases, unauthorized deployments of shadow AI pose significant risks to enterprises. Shadow AI can introduce vulnerabilities, data leaks, or other security threats that evade traditional security measures. Traditional systems often rely on agents, which require installation and maintenance. The disclosed technology, on the other hand, proposes an agentless approach that efficiently detects and manages shadow AI threats by inspecting cloned workloads in a secure environment. For example, the disclosed technology can generate cloned copies of workloads from a cloud environment, analyze those workloads for AI-related threats using the disclosed techniques, and store analyses and related information in a security database for ongoing analysis and threat correlation. As described herein, the disclosed technology can leverage signature-based, heuristic-based, and other detection techniques to detect and respond to shadow, vulnerable, and/or malicious AI in cloud and other enterprise information technology (IT) environments.

One or more embodiments described herein can include a method for monitoring artificial intelligence (AI) and responding to cybersecurity threats in a computing, the method including: monitoring, in real-time, computational resources and network traffic to identify potential AI operations, detecting, using signatures, the potential AI operations, determining AI-specific behavioral patterns based on applying heuristics to the detected AI operations, identifying deviations of the detected AI operations from normal operational patterns using deep learning anomaly detection techniques, and returning information about the identified deviations of the detected AI operations.

In some implementations, the embodiments described herein can optionally include one or more of the following features. For example, the computational resources can include CPU, GPU, and/or TPU usage, utilization, and/or associated anomalies. In some implementations, the information about the identified deviations of the detected AI operations can include at least one of: (i) genealogy, (ii) input identification, (iii) poisoning, or (iv) a type of activity. The method can also include augmenting the monitored computational resources and network and/or system traffic to reduce false positives and predict or mitigate new threats. Sometimes, the method can also include generating fingerprints for trained machine learning models in an AI environment. Identifying the deviations of the detected AI operations can be further based on using the fingerprints to monitor usage, versioning, and instances of the respective trained machine learning models in the AI environment.

In some implementations, returning the information can include generating an automated response to the identified deviations of the detected AI operations. The automated response can include retraining a machine learning model associated with the detected AI operations. The automated response can include updating a configuration in an AI environment of the detected AI operations. The automated response can include adjusting access controls for one or more uses in an AI environment of the detected AI operations.

As another example, monitoring the computational resources and the network traffic can include: generating cloned copies of workloads from a cloud computing environment, and analyzing the cloned copies of workloads to identifying the deviations of the detected AI operations. The method can also include storing results from analyzing the cloned copies of workloads for ongoing analysis and threat correlation. Sometimes, the method can include: concurrently monitoring hardware, middleware, and software layers of an AI system to identify potential AI operations, correlating the identified potential AI operations across the layers, performing if/then processing of the identified AI operations to identify anomalies in the identified AI operations, and returning information about the identified anomalies.

One or more embodiments described herein can include a method for detecting and mitigating threats in an artificial intelligence (AI) environment, the method including: generating cloned copies of workloads from a cloud computing environment, detecting AI operations based on the cloned copies of workloads, identifying deviations of the detected AI operations from normal operational patterns using deep learning anomaly detection techniques, and returning information about the identified deviations of the detected AI operations.

The method can optionally include one or more of the abovementioned features and/or one or more of the following features. For example, the identified deviations of the detected AI operations can include shadow AI instances in the cloud computing environment. Identifying the deviations can include detecting shadow AI instances in the cloud computing environment based on signatures or heuristics. The signatures can include unauthorized model signatures and API pattern signatures. The heuristics can include abnormal data access and resource spikes.

One or more embodiments described herein can include a method for detecting and mitigating threats in an artificial intelligence (AI) environment, the method including: concurrently monitoring hardware, middleware, and software layers of an AI system to identify potential AI operations, correlating the identified potential AI operations across the layers, performing if/then processing of the identified AI operations to identify anomalies in the identified AI operations, and returning information about the identified anomalies.

The method can optionally include one or more of the abovementioned features and/or one or more of the following features. For example, the method can also include dynamically updating signature analysis based on the correlating for real-time threat detection. The if/then processing can be performed based on applying a large language model (LLM) to the identified AI operations. Returning the information about the identified anomalies can include performing automated actions to isolate containers in the AI system. Returning the information about the identified anomalies can include performing automated actions to terminate rogue processes in the AI system. Concurrently monitoring hardware, middleware, and software layers of an AI system can include applying an AI model to identify hardware usage patterns of unauthorized AI processes in the hardware layer. In some implementations, concurrently monitoring hardware, middleware, and software layers of an AI system can include applying an AI model to correlate suspicious middleware events with unauthorized AI execution in the middleware layer. Sometimes, concurrently monitoring hardware, middleware, and software layers of an AI system can include applying an AI model to recognized unsanctioned software behavior linked to shadow AI operations in the software layer.

The devices, system, and techniques described herein may provide one or more of the following advantages. For example, while conventional cybersecurity solutions focus on network and endpoint security, the disclosed technology addresses the unique challenges posed by AI environments. By integrating advanced techniques in AI introspection, anomaly detection, and threat intelligence integration, the disclosed technology offers a comprehensive, technical, and automated solution that enhances the security and resilience of enterprise AI systems. Moreover, the disclosed technology improves existing technologies and methodologies by leveraging existing cybersecurity frameworks, such as MITRE ATLAS, as a foundational framework for mapping and categorizing threats, tactics, and techniques associated with AI attacks. By integrating AI-specific threat intelligence and anomaly detection capabilities with the existing frameworks, the disclosed technology enhances the visibility, effectiveness, and scalability of enterprise AI security operations, enabling enterprises to defend against emerging threats and mitigate risks effectively.

Implementing the disclosed technology can result in technical effects and improvements that enhance the security posture and operational efficiency to enumerate AI running and its integrity. Such technical improvements include, for example, increased enumeration visibility. The disclosed technology combines fingerprinting techniques to enumerate: what AI is running as well as related threats, vulnerabilities, and/or risk. Such techniques may include but are not limited to regression, correlation, and/or machine learning advances that observe GPU/CPU and other fingerprints at all layers of the stack and throughout the machine learning operations (MLOps) lifecycle.

The technical improvements include improved monitoring. The disclosed technology builds off the unique fingerprinting described herein to develop a heuristic and patterns and correlation to improve detection in enterprise endpoints. That heuristic can be measured against frameworks such as MITRE. The technical improvements can also include improved resource utilization. By enumerating heuristics on what is running and its state, the disclosed technology can improve utilization and reduce costs. For example, RAG or other optimizations that are light and fast can be employed to accomplish tasks described herein. The technical improvements can include increased accuracy. The disclosed technology can improve the accuracy of AI specific threat detection and risk mitigation by leveraging AI-driven analytics and anomaly detection algorithms. The disclosed technology, as a result, achieves higher detection rates and lower false positive rates compared to traditional cybersecurity solutions. The technical improvements can also include enhanced efficiency. The disclosed technology enhances operational efficiency by automating the detection, analysis, and response to security threats. Performance metrics can show significant reductions in incident response times and manual intervention requirements, leading to overall cost savings and resource optimization. Moreover, as described herein, the disclosed technology is designed for scalability, providing yet another technical improvement.

Traditional systems lack visibility into AI deployments and activities within an enterprise, and may also have difficulty in distinguishing between legitimate AI activities and potential threats. The disclosed technology provides technical solutions by providing deep analysis of AI algorithms, models, and data pipelines, offering granular visibility into AI systems' architectures, behaviors, and interactions. The disclosed technology also employs advanced machine learning algorithms and/or statistical analysis techniques to identify abnormal behavior and suspicious patterns within AI systems, enabling the detection of potential threats and anomalies in real-time. Traditional systems may have limited integration with existing system frameworks and compliance standards. The disclosed technology provides a technical solution by integrating with existing frameworks, such as MITRE ATLAS, mapping and categorizing threats, tactics, and techniques associated with AI attacks, and thus ensuring alignment with industry-standard security frameworks and compliance requirements. Similarly, the traditional systems face challenges in maintaining compliance with regulatory requirements and standards. The disclosed technology, on the other hand, provides comprehensive compliance and audit trail capabilities by generating detailed logs, reports, and audit trails that document security events, mitigation actions, and compliance status to facilitate regulatory compliance and accountability in AI system operations. As another example, traditional systems may not adapt to the dynamic nature of AI environments and evolving threats. The disclosed technology, on the other hand, employs adaptive controls to respond to detected threats and vulnerabilities in real-time, automatically triggering remediation actions and adjusting security controls based on threat intelligence and anomaly detection results. The traditional systems also may lack scalability and performance optimization to support large-scale AI deployments. The disclosed technology is designed for scalability and performance optimization, using distributed processing architectures and cloud-native technologies to support deployment across large-scale enterprise AI ecosystems without compromising performance or reliability.

Furthermore, the technical solutions provided by the disclosed technology may not be reasonably performed in the human mind. It is impractical for the human mind to receive hundreds to thousands of datapoints in network data, and, in real-time or near real-time, process the data through the technical pipeline described herein to generate valuable insights, mitigation, and audit trails of detected threats in ever-changing AI environments. It would be impractical for the human mind to leverage a combination of advanced computational techniques, including but not limited to fingerprinting, integrity enumeration, anomaly detection, and threat intelligence integration, to provide a comprehensive and effective approach to identifying, detecting, and mitigating risks associated with AI systems deployed within enterprises in real-time. By addressing the unique challenges of AI system fingerprinting and security, the disclosed technology therefore empowers the adoption and leveraging of AI technologies with increased confidence, resilience, accuracy, and efficiencies.

As described herein, the disclosed technology provides for automatic and accurate detection and mitigation of unauthorized or shadow AI in enterprises. Traditional systems can monitor system or network activity, but may lack the capability to detect AI-specific workloads and correlate data across layers in a technology stack. The disclosed technology provides technical solutions by providing a holistic, multi-layered approach to detect and provide real-time dynamic responses to anomalies such as unauthorized or shadow AI. The disclosed technology can be specifically tuned to the complexity of AI workloads, unlike the traditional systems. Advantageously, the disclosed technology can also adapt dynamically and based on heuristics, unlike static detection systems, which allows for the technology to respond to every-changing threats in AI ecosystems.

Moreover, the disclosed technology provides an automated and agentless approach to detect shadow AI in cloud-based AI systems and/or applications. The agentless approach of the disclosed technology provides non-intrusive detection without impacting workloads in the cloud environment. Workload cloning techniques also allow for the preservation of privacy within the cloud-based environment. The agentless operation also can reduce maintenance overhead and other costs associated with analyzing the workloads for shadow AI detection. Unlike traditional systems, the disclosed technology is configured for AI-specific detection capabilities. Additionally, the disclosed technology can be scalable across large computing environments, allows for continuous monitoring to detect shadow AI threats and a holistic threat assessment with combined detection methods (which also allows for adaptive learning to be responsive to new types of AI threats), and focuses on AI integrity, including data poisoning prevention.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for detecting and responding to threats in AI systems;

FIG. 2 illustrates an example of monitored CPU frequencies;

FIG. 3 illustrates an example table of GPU and CPU data for resource utilization and performance metrics associated with AI model training and inference tasks;

FIG. 4 is a table illustrating example anomaly detection techniques capable of identifying abnormal behavior and suspicious patterns within AI systems;

FIG. 5 illustrates example anomaly detection risk assessments and prioritization of potential threats using the disclosed technology;

FIGS. 6A and 6B illustrate example workflows for identifying and mitigating shadow AI activities across an entire AI technology stack;

FIG. 7 illustrates an example table for adapting AI system monitoring techniques at different layers using the disclosed technology to improve detection of AI use and abuse;

FIG. 8 is a table of example signatures that may be analyzed for real-time threat detection;

FIG. 9 is a table of example signatures that may be observed, clustered, and correlated to improve AI anomaly detection techniques;

FIG. 10 illustrates example coverage areas for integrating the disclosed technology with frameworks such as MITRE ATLAS;

FIG. 11 is a flowchart of a process for detecting and managing shadow AI threats by inspecting cloned workloads in a secure environment; and

FIG. 12 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to technology for addressing cybersecurity, compliance, and risk challenges inherent in AI systems. The disclosed technology, as described herein, may include an AI identification module, an anomaly detection engine, threat intelligence integration, dynamic risk mitigation policies, scalability and performance optimization, and/or AI compliance and audit trails.

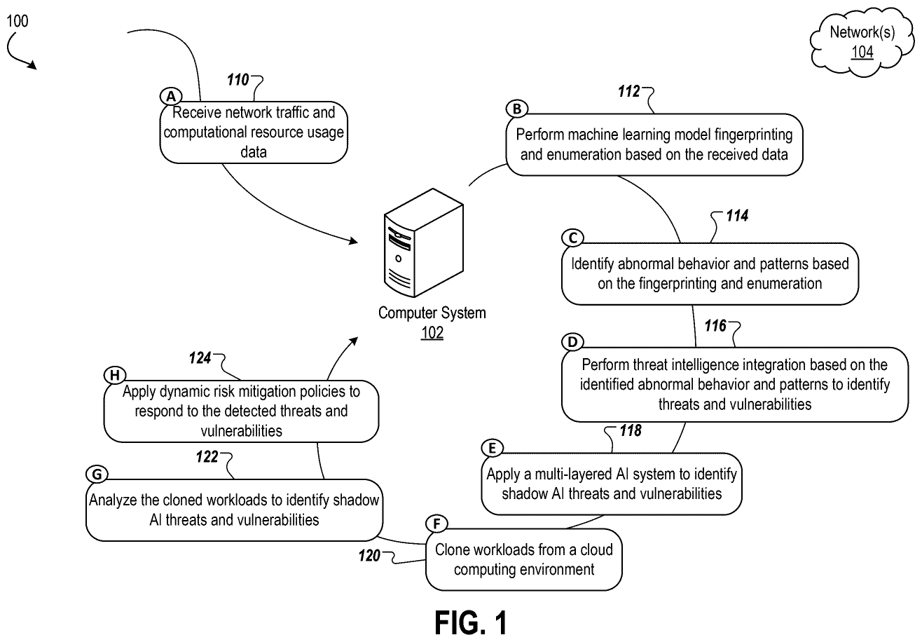

Referring to the figures, FIG. 1 is a conceptual diagram of a system 100 for detecting and responding to threats in AI systems. The system 100 can include the computer system 102, which can communicate with other computing systems, cloud-based systems, computing environments, data stores, and/or AI systems via network(s) 104. The computer system 102 can perform the disclosed techniques. In some implementations, the computer system 102 can implement or otherwise execute one or more AI systems for an enterprise, the AI systems being assessed using the disclosed techniques.

In block A (110), the computer system 102 can obtain network traffic data and/or computational resource usage data from one or more sources. The obtained data can include but is not limited to application and/or service log data, storage and/or data access data/patterns, CPU and/or GPU usage data, API and/or SDK calls data, power and/or thermal monitoring data, user activity and/or command tracking data, license and/or software inventory data, containerization and/or virtualization data, and/or automated code and/or other software data. The computer system 102 can be integrated and/or in network communication via the network(s) 104 with one or more different systems, databases, datastores, and/or data collection layers, from which the computer system 102 can receive the network traffic and/or the computational resource usage data. Once the data is received, the computer system 102 can optionally perform data normalization and/or cleansing techniques.

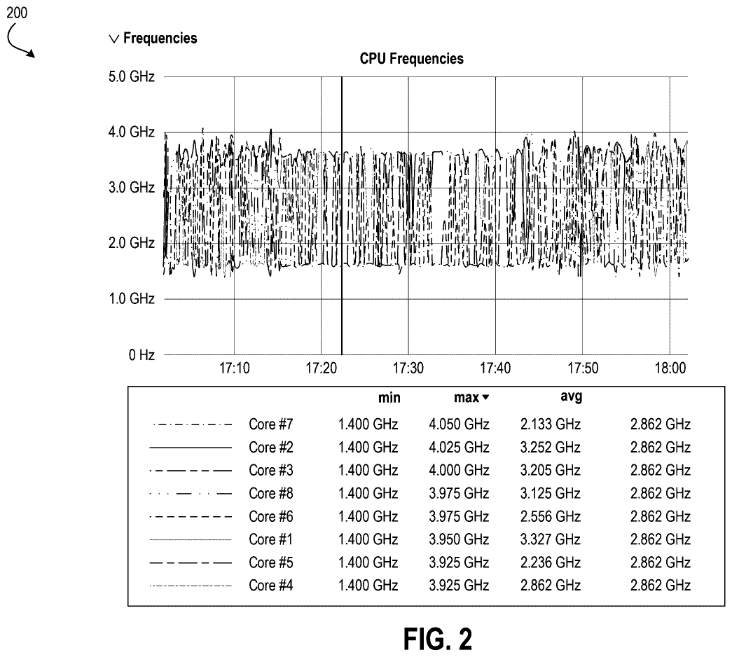

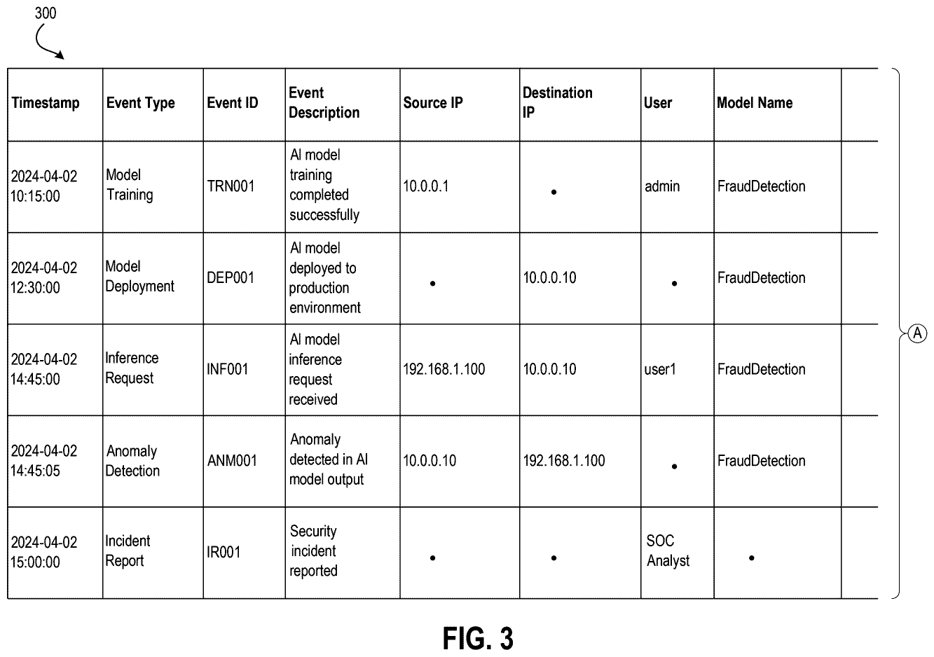

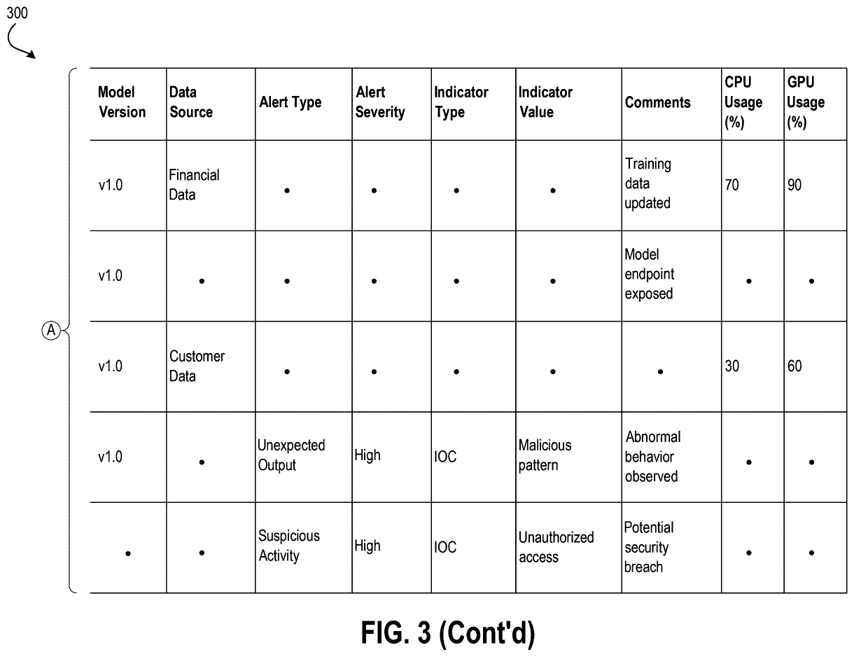

The computer system 102 can include an AI identification module, which can be configured to perform machine learning model fingerprinting and/or enumeration techniques described further in reference to Table 1, Table 2, Table 3, and FIGS. 2 and 3 (block B, 112). The disclosed technology can enable deep analysis of AI algorithms, models, and data pipelines, providing insights into potential vulnerabilities and security weaknesses that may be overlooked by traditional cybersecurity solutions. By monitoring AI systems at a granular level as shown in initial signatures/heuristics described herein, the disclosed technology enhances the effectiveness and accuracy of threat detection and mitigation. Sometimes, the identification techniques in block B can include data normalization, data cleansing, event correlation, pattern recognition, and/or identification of potential AI usage and/or security risks.

Machine learning (ML) model fingerprinting can be used to generate unique identifiers and/or signatures for trained machine learning models. These fingerprints can then be used with the disclosed technology for model versioning, tracking model usage, and/or identifying instances of specific models within an enterprise's infrastructure or network. The fingerprinting can be performed, for example, by the AI identification module of the disclosed technology. One or more different techniques may be incorporated into the fingerprinting and enumeration operations to employ a multi-layered approach to AI detection and security. For example, merely illustrative examples of different techniques for enumeration are illustrated in Table 1, reproduced below.

TABLE 1
AI/ML Model Fingerprinting Techniques

| Technique | AI/ML Model Fingerprinting |
|---|---|
| Hashing Techniques | Apply cryptographic hashing to model binary for a unique identifier. |
| Model Metadata | Extract model details like architecture, hyperparameters, and |
| Extraction | performance metrics for fingerprinting. |
| Feature Extraction | Extract features from intermediate model layers for fingerprint |
| | generation. |
| Graph-based | Create a computational graph to capture model topology for |
| Representation | fingerprinting. |
| Model Quantization | Convert model parameters to fixed-point representations and fingerprint |
| | the quantized model. |
| Performance | Generate a signature based on model behavior metrics like inference |
| Signature | latency and accuracy. |
| Embedding-based | Utilize embeddings for textual metadata like documentation or |
| Techniques | comments for fingerprinting. |
| Ensemble Model | Generate composite fingerprints for ensemble models based on |
| Fingerprinting | individual model fingerprints. |
| Version Control | Integrate fingerprinting with version control systems for model |
| Integration | tracking. |
| Regular Update of | Keep fingerprints up to date to reflect changes in models and data. |
| Fingerprints | |

Once AI/ML systems are discovered using the disclosed technology, such as the AI identification model, one or more additional operations may be performed to detect their integrity and/or state of integrity. The following Table 2, reproduced below, illustrates one or more illustrative operations that can be performed to assess AI algorithms, models, and/or data pipelines for identifying potential vulnerabilities and/or security weaknesses:

TABLE 2
AI/ML Techniques to Identify Vulnerabilities

| Technique | Method Description |
|---|---|
| Sequence modeling | Sequence modeling for analyzing system, process, and execution |
| | behaviors over time. Used to detect characteristic execution sequences |
| | associated with AI model training, inference, or fine-tuning pipelines |
| | and deviations from established baselines. |
| Utilization | Resource utilization indicative of AI workloads, such as CPU/GPU |
| | usage patterns, memory pressure, and accelerator utilization |
| | correlated with model execution. This includes identifying shifts from |
| | baseline behavior and understanding what “normal” looks like from a |
| | security and cost perspective. |
| Configuration and Code | Analyzes patterns in source code, configuration files, model artifacts, |
| | and data flows associated with AI algorithms and pipelines. This |
| | includes identifying ML frameworks, training scripts, model |
| | serialization formats, and orchestration logic. |
| User activity and | Tracks user-initiated actions such as command-line execution, |
| command tracking | notebook usage, shell history, and orchestration commands related to |
| | model training, inference, or deployment. Useful for detecting |
| | unauthorized experimentation, shadow AI usage, or anomalous |
| | operator behavior. |
| Application and service | Monitors logs from applications, ML services, orchestration |
| log monitoring | platforms, and inference endpoints. Focuses on error patterns, job |
| | lifecycle events, model load events, authentication failures, and |
| | abnormal execution paths. |
| Storage and data access | Monitors access to datasets, model artifacts, and feature stores. |
| pattern tracking | Includes detection of access patterns consistent with ML frameworks |
| | such as TensorFlow Serving, PyTorch, Keras, or scikit-learn, as well |
| | as container-based deployments using Docker, Kubernetes, or similar |
| | platforms. |
| Run time, CPU/GPU | Correlates execution duration with CPU/GPU utilization to identify |
| usage | inference versus training workloads, batch versus real-time execution, |
| | and anomalous runtime behavior such as cryptomining or data |
| | exfiltration disguised as model execution. |
| API and SDK call | Observes API and SDK usage patterns for ML services and cloud |
| monitoring | platforms. Indicators include spikes outside normal business hours, |
| | use of deprecated or legacy APIs, elevated error rates, abnormal |
| | latency, or response code patterns associated with abuse or attack |
| | activity. |
| Network traffic analysis | Analyzes inbound and outbound network traffic associated with AI |
| | workloads. Examples include large or sustained data transfers to |
| | unfamiliar external IP addresses, unexpected model download/upload |
| | activity, and traffic patterns that deviate from established baselines. |
| License and software | Maintains visibility into installed ML frameworks, libraries, drivers, |
| inventory analysis | and licensed software. Helps identify unauthorized ML tooling, policy |
| | violations, unsupported versions, and shadow AI environments |
| | operating outside approved governance controls. |

There can be, in some implementations, one or more limitations in the above-described approaches, which can be overcome in part via correlation of AI signatures and heuristics. As an illustrative example, consider monitoring API calls, where resource spikes can be normal for large models (e.g., Transformer-based models), and similarly, large call volumes may be due to legitimate requests. However, spikes outside normal business hours, use of legacy API functions, and/or high number of error rates when combined with abnormal response codes or latency patterns may be indicative of an attack, as reflected in Table 3:

TABLE 3
Correlation of AI Signatures and Heuristics

| | | | Observable |
|---|---|---|---|
| Category | Example Signatures | Heuristics | Behaviors |
| API Usage Patterns | High frequency of | Spikes in API calls | Unusual volume of |
| (OpenAI, Google | model inference | outside of normal | calls for text |
| Cloud AI) | requests | business hours | generation or |
| | | | translation |
| Data Access Patterns | Large data payloads | Transfers of | Multiple uploads of |
| (AWS Sagemaker, | sent to endpoints | uncommon data | non-standard formats |
| Azure AI) | | formats or | like multimedia |
| | | unexpected datasets | content |
| Authentication & | Repeated failed token | Abnormal OAuth | Unusual access |
| Authorization | validation attempts | token refresh rates | patterns or location- |
| (Microsoft Cognitive | | or unused API keys | based access |
| Services) | | | anomalies |
| SDK Function Usage | Rare or deprecated | Use of legacy API | Inconsistent or |
| (TensorFlow, | functions invoked in | functions for model | unusual function |
| PyTorch) | training workflows | deployment | calls, such as |
| | | | deprecated APIs |
| Resource | GPU/TPU compute | High resource | Unexpected spikes in |
| Consumption | spikes with API | utilization during | memory or compute |
| (Hugging Face | calls | typical low-usage | during training or |
| Transformers, | | periods | inference |
| Google TPU) | | | |
| Anomaly Detection | Abnormal response | Increased API error | Unusual delays in |
| (IBM Watson, NLP | codes or latency | rates, unique | response times or |
| Cloud) | patterns | exception codes | model output |
| | | logged | irregularities |

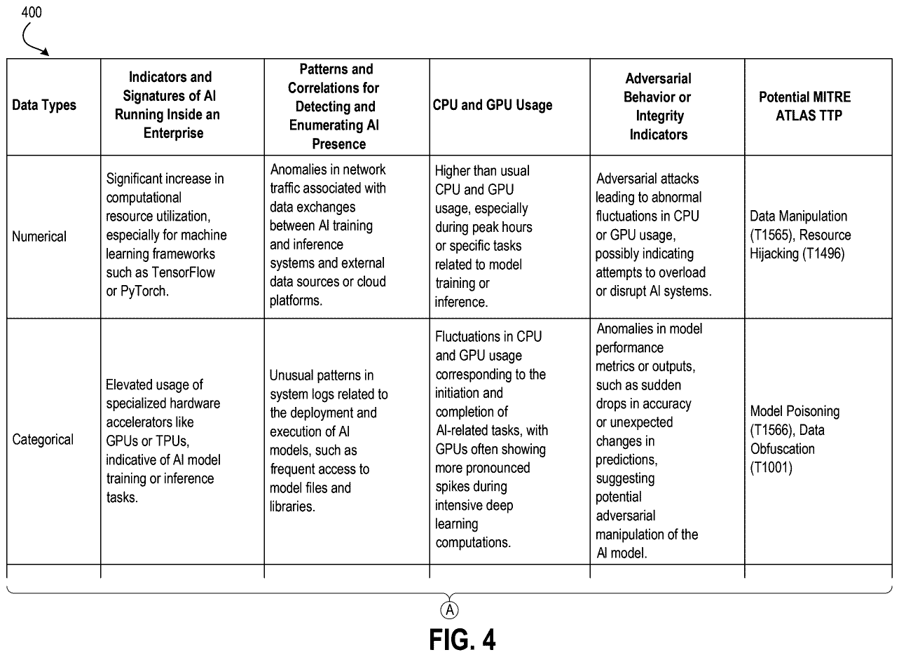

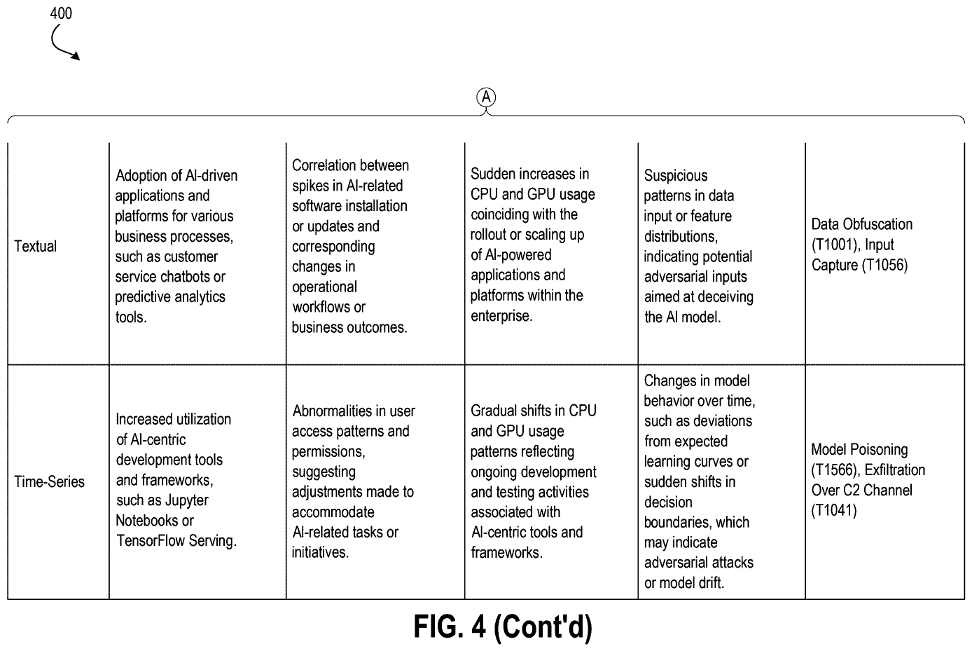

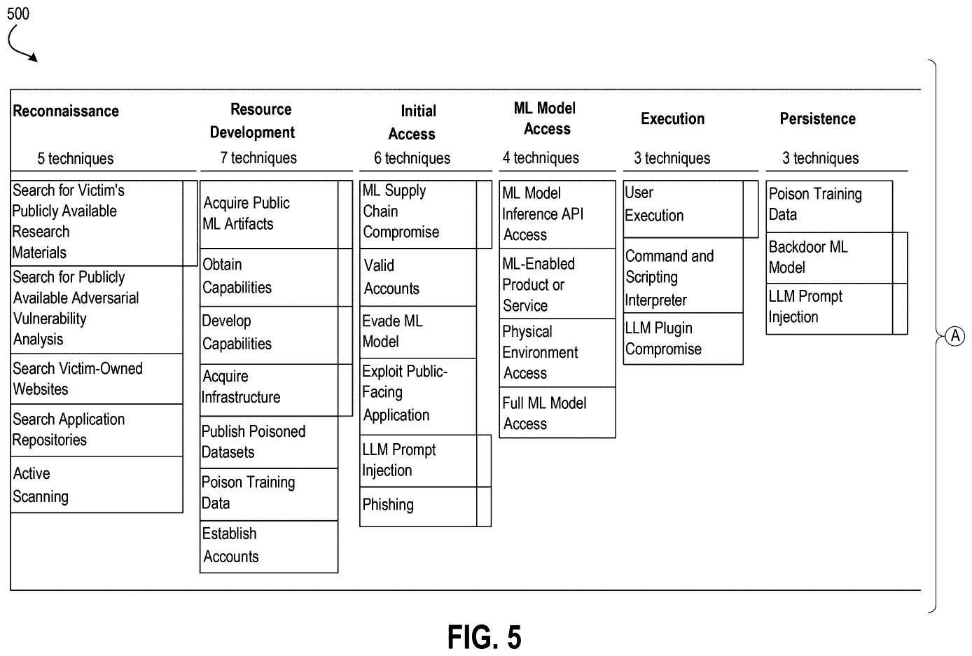

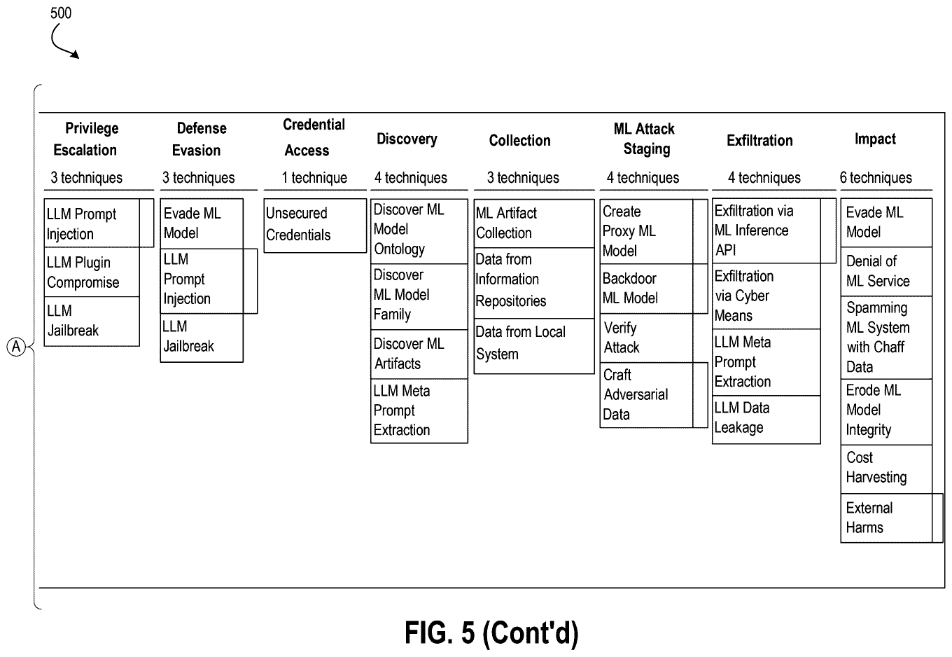

The computer system 102 can have an anomaly detection engine, which can be configured to identify anomalous behaviors and patterns in AI systems (block C, 114). Refer to FIGS. 4 and 5 and Table 4 for further discussion. The computer system 102 may also apply one or more Security Orchestration, Automation, and Response (SOAR) automation and/or rules for confirmed AI threats (and to contain and/or remediate such threats). The automation may correspond to different confidence levels of the machine learning and/or AI models.

In block D (116), the computer system 102 can integrate the disclosed technology with external threat intelligence feeds and/or databases to provide real-time information on emerging threats, vulnerabilities, and/or attack vectors that may target AI technologies and systems. Thus, the computer system 102 can identify threats and vulnerabilities based on performing threat intelligence integration techniques. This feature enables proactive threat hunting and incident response, allowing enterprises to stay ahead of evolving cybersecurity threats and mitigate risks effectively. For example, the computer system 102 can continuously ingest and analyze threat intelligence to identify potential vulnerabilities, attack vectors, and/or emerging threats targeting AI systems. The computer system can also correlate the threat intelligence with the AI system fingerprinting and anomaly detection data to prioritize and address the most critical risks to the AI systems.

In some implementations, the computer system 102 can integrate frameworks such as MITRE ATLAS/ATT&CK and Kill Chain Mapping (which describes phases or stages of a targeted cyberattack, such as Reconnaissance, Weaponization, Delivery, Exploitation, Installation, Command and Control, and Actions on Objectives) to provide a comprehensive overview of the tactics, techniques, and procedures (TTPs) used by adversaries during various stages of an attack lifecycle. The disclosed techniques can automatically categorize adversary behavior into different tactical categories, such as Initial Access, Execution, Persistence, and Command and Control, and also provide a detailed description of the techniques and sub-techniques employed by threat actors. Existing frameworks may also be combined with the disclosed technology to improve an AI knowledge base and/or increase clustering techniques around high probability events and/or alerts. Integration can also occur with open source threat intelligence databases to determine not only if an AI system is vulnerable, but also to determine whether public exposure will facilitate prioritization of detection gaps. The computer system 102 can also enable proactive threat hunting and incident response by correlating internal security events with external threat intelligence sources.

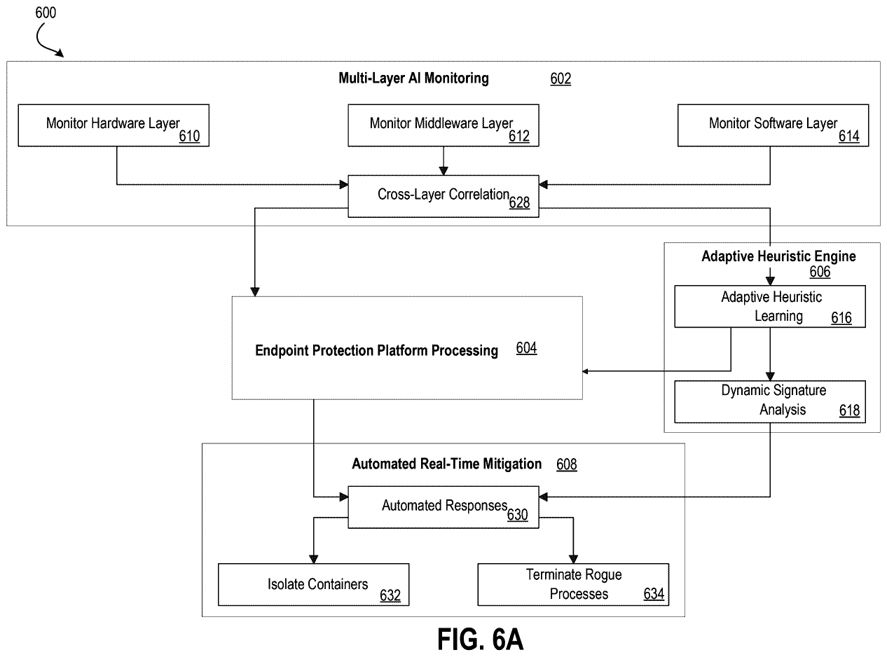

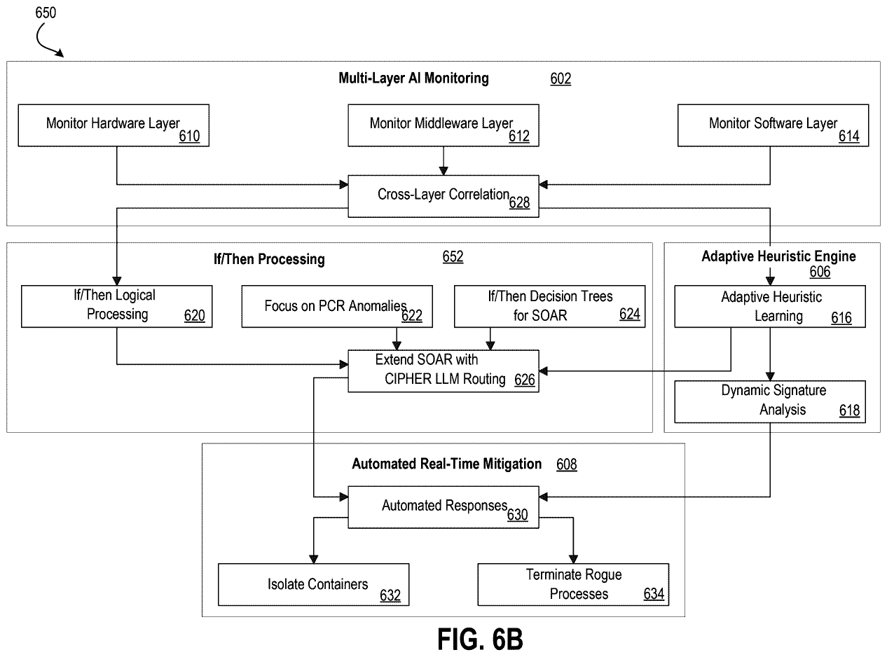

The computer system 102 can apply a multi-layered AI system to identify and mitigate shadow AI threats and vulnerabilities across an enterprise (block E, 118). Refer to at least FIGS. 6, 7, 8, 9, 10, and 11 for further discussion about identifying and mitigating the shadow AI activities.

The computer system 102 can clone workloads from a cloud computing environment in block F (120). Cloning the workloads allows for automated inspection of the workloads for AI-related threats using the disclosed techniques. As a result of cloning, the original workloads are not affected and shadow AI can be detected with an agentless approach.

Accordingly, the computer system 102 can analyze the cloned workloads to identify shadow AI threats and/or vulnerabilities in block G (122). For example, the computer system 102 can perform Isolation Forest techniques to detect anomalies in the cloned workloads. The computer system 102 may apply Long Short-Term Memory (LSTM) networks to analyze temporal AI patterns in the cloned workloads. Sometimes, the computer system 102 can use graph convolutional networks (GCNs) for component relationship analysis and XBGoost methods for threat prioritization. Once the shadow AI threats are detected, the computer system 102 can also apply ensemble methods and/or gradient descent for further exploration and continuous monitoring of the cloud computing environment. The computer system 102 can also apply one or more security frameworks to improve detection of different types of shadow AI threats across different cloud computing environments, those frameworks including but not limited to MITRE ATLAS, MITRE ATT&CK, etc.

Still referring to block G (122), the computer system 102 can implement techniques described herein, such as signature-based and/or heuristic-based techniques to assess the workloads, ensure integrity of the cloud-based AI systems, and respond to AI-related threats. The computer system 102 therefore can provide for agentless shadow AI detection. Any detected shadow AI can be linked or otherwise associated with each other, the cloned workloads, and/or the cloud computing environment (e.g., in a database or data store) to allow for continuous monitoring. Refer to FIGS. 6A and 6B for further discussion about identifying the shadow AI threats and/or vulnerabilities by analyzing the cloned workloads from the cloud AI systems.

In some implementations, blocks F and G (120 and 122, respectively) can be performed as part of block E (118). Sometimes, blocks F and G (120 and 122, respectively) can be performed before or in lieu of block E (118). Sometimes, block F (120) can be performed as part of or in response to performing block B (112). As another example, block G (122) can be performed as part of block C (114) or block D (116).

In block H (124), the computer system 102 can employ dynamic risk mitigation policies and adaptive controls to respond to the detected threats and vulnerabilities in real-time. By automatically triggering remediation actions and adjusting security controls based on threat intelligence and anomaly detection results, the disclosed technology enhances the agility and responsiveness of enterprise AI security operations. For example, the disclosed technology can automatically trigger remediation actions, such as model retraining, configuration updates, or access controls adjustments, to mitigate identified risks and enhance system resilience. The triggers can be automated via AI agents associated with confidence levels as measured via PCR, Confusion Matrix, and/or other similar techniques.

As described herein, the computer system 102 can perform one or more machine learning and/or rule-based analytics to generate insights, alerts, and/or reports about AI usage and/or security risks. The computer system can also generate graphical user interfaces (GUIs) and dashboards for presentation of the determined insights, alerts, and/or reports. The dashboards can, in some implementations, be customized for different monitoring and/or investigative techniques. The GUIs and dashboards may also provide visualization of identified AI usage and/or security risks for enterprises.

The disclosed technology is designed for scalability and performance optimization to support deployment across large-scale enterprise ecosystems. It utilizes distributed processing architectures and cloud-native technologies to ensure seamless integration with existing IT infrastructures and operational workflows. The disclosed technology can also use one or more techniques and operations to ensure data standardization across an enterprise or other ecosystem. Moreover, the disclosed technology can provide comprehensive compliance and audit trail capabilities to facilitate regulatory compliance and accountability in AI system operations. The disclosed technology can generate detailed logs, reports, and/or audit trails to document security events, mitigation actions, and/or compliance status for internal and external stakeholders.

FIG. 2 illustrates an example graph 200 of monitored CPU frequencies. FIG. 3 illustrates an example table 300 of GPU and CPU data for resource utilization and performance metrics associated with AI model training and inference tasks. The techniques described in reference to FIGS. 2 and 3 can be performed by an AI identification module of the disclosed technology. Referring to both FIGS. 2 and 3, while GPUs and/or specialized AI accelerators can significantly boost performance for certain AI workloads, they may not be necessary or cost-effective for all AI systems, especially those with relatively modest computational requirements and/or those focused on tasks that may not be heavily parallelizable. In such cases, the AI system may rely primarily on high-performance CPUs or a combination of CPUs and other hardware accelerators. The disclosed technology can be used to identify and characterize these workloads to generate valuable insight on cost effective AI use, as shown by FIG. 2.

As shown in the graph 200 of FIG. 2, the disclosed technology can provide a platform that monitors CPU and/or GPU activities. The platform can expose characteristics such as temperature, power draw, utilization, fan rpms, and/or the same or similar on CPU, GPU, disk, RAM, etc. Such data can be collected and ingested by the disclosed technology to fingerprint and monitor AI usage and/or states.

CPU and/or GPU usage monitoring on its own can be powerful. Augmenting such information with the disclosed data and telemetry can help reduce false positives and also predict and/or mitigate new threats. One approach can include monitoring AI CPUs and/or GPUs within an enterprise by monitoring system resources, analyzing network traffic patterns, and inspecting process characteristics. The table 300 in FIG. 3 illustrates these concepts. One of the challenges is that since many AI workloads can run with the use of existing software and hardware infrastructure, and since the intelligence can be encoded within weights of the model and not with code, it may not be possible to analyze it prior to execution, and it therefore can be challenging to identify if an attacker has modified or substituted a different model.

Moreover, the disclosed technology can analyze model architectures, input-output patterns, and/or training data distributions to detect deviations indicative of adversarial attacks and/or model manipulation. Examples may include perturbations in input data. The perturbations can include small changes, that may be difficult to see or identify, and have the potential for large effects. Signatures, for example, may demonstrate slight, often imperceptible modifications to input data (e.g., images, text, audio), which may appear innocuous to humans but can drastically alter an AI model's output. Heuristics may be used to detect inputs that have a higher-than-normal level of noise or small pixel changes, which may not correspond to significant semantic differences. Additionally, high volumes of sequential queries with slight variations, encoded, and/or obfuscated data to bypass input sanitization and filtering (e.g., url-encoded strings, base code 64 encoded data) may be identified using the disclosed technology to detect deviations indicative of adversarial attacks and/or model manipulation.

FIG. 4 is a table 400 illustrating example anomaly detection techniques capable of identifying abnormal behavior and suspicious patterns within AI systems. The techniques described in reference to FIG. 4 can be performed by an anomaly detection engine of the disclosed technology.

The anomaly detection engine, for example, can incorporate existing and new signatures, heuristics and correlations of anomalous behavior across one or more enterprises. One or more different ML models and/or large language models (LLMs) can be used by the engine to identify patterns of anomalous behavior. In some implementations, the disclosed technology can include a retrieval-augmented generation (RAG) architecture to incorporate new data into pre-trained model's corpus in a timely way that improves performance and context. The disclosed technology can therefore be used to dynamically and automatically assess behavior of AI tools within an enterprise, which can encompass typical usage patterns, frequency of model training and inference, and/or resource consumption, as reflected in Table 4 reproduced below.

TABLE 4
Pattern Detection Techniques

| Component | Description |
|---|---|
| Data Collection | Collects data from various sources within the |
| | organization's infrastructure, including code |
| | repositories, execution logs, configuration files, |
| | and communication channels. |
| Feature Extraction | Extracts relevant features from the collected data, |
| | such as metadata from machine learning models, |
| | code patterns, execution patterns, and |
| | communication patterns. |
| Normal Behavior | Builds a model of normal behavior for AI tools |
| Modeling | within the organization, encompassing typical usage |
| | patterns, frequency of model training and inference, |
| | and resource consumption. |
| Anomaly Detection | Identifies deviations from the established normal |
| | behavior model as anomalies using statistical |
| | methods, machine learning algorithms, or deep |
| | learning models. |
| Fingerprinting | Generates fingerprints or signatures for known AI |
| | tools and workflows within the organization, |
| | capturing unique characteristics such as metadata |
| | and code patterns. |
| Comparison and | Compares observed behavior with the normal |
| Classification | behavior model and known fingerprints to classify |
| | behavior as normal or anomalous. |
| Adaptive Learning | Continuously adapts and updates models based on |
| | new data and feedback, improving the architecture's |
| | ability to detect anomalies and identify new AI tool |
| | fingerprints. |

Once the AI is enumerated, such as by using one or more of the techniques shown and described above in reference to Table 4, the disclosed technology can perform techniques for identifying abnormal behavior and suspicious patterns within the AI system with a focus on enumeration around popular security frameworks. An illustrative example of these security frameworks is shown in the table 400 of FIG. 4. For example, the security framework can include but is not limited to MITRE ATLAS. The MITRE ATLAS framework, for example, can provide insights into identifying and detecting different types of AI threats and/or vulnerabilities.

The disclosed technology can facilitate automation of the chosen security framework and/or other libraries to test AI integrity using, as an illustrative example, a CI/CD pipeline, which can systematically execute TTP simulations against the AI model in a controlled environment. As another example, the disclosed technology can use existing or custom automation frameworks, such as SELENIUM, PYTEST, or custom scripts. As yet another example, the disclosed technology can use techniques such as POISON TRAINING DATA and/or BACKDOOR ML MODEL to inject adversarial samples and validate if the model's outputs deviate from expected behavior. As another example, the disclosed technology can use LLM JAILBREAK or other similar techniques to test the model's robustness against manipulated inputs. Additionally or alternatively, the disclosed technology can use model inference API access techniques to measure the system's response to unauthorized queries. One or more other techniques are also possible.

FIG. 5 illustrates a table 500 of example anomaly detection risk assessments and prioritization of potential threats using the disclosed technology. The disclosed technology can leverage machine learning algorithms and/or statistical analysis techniques to detect deviations from expected norms in AI training, inference, and/or performance metrics. For example, AI threat detection and analysis operations can include one or more machine learning model fingerprinting techniques to generate unique identifiers and/or signatures for trained machine learning models. These fingerprints can be used throughout the AI lifecycle and can help identify what is running, model versioning, tracking model usage, or identifying instances of specific models within an enterprise's infrastructure. The Detection and Analysis module described herein may include the one or more of the following techniques for ML model fingerprinting: correlating observed behaviors with known AI threats and TTPs and/or generating frameworks′, such as MITRE ATLAS, risk assessments and prioritizing threats, as shown in the table 500 of FIG. 5.

FIGS. 6A and 6B illustrate example workflows 600 and 650 respectively for identifying and mitigating shadow AI activities across an entire AI technology stack. Each component of multi-layer AI monitoring 602, endpoint protection platform processing 604 of the workflow 600, If/Then processing 652 of the workflow 650, adaptive heuristics 606, and automated real-time mitigation 608 operations can be integrated into the disclosed technology to automatically detect and respond to unauthorized or shadow AI activities in any enterprise.

As shown by both the example workflows 600 and 650 of FIGS. 6A and 6B, the disclosed technology can implement multi-layer AI monitoring techniques (602) to monitor hardware 610, middleware 612, and software 614 layers concurrently, thereby allowing for comprehensive tracking of AI activities. The disclosed technology can implement signature detection algorithms, such as pattern matching algorithms to detect AI library usage, AI-related API calls, and/or unauthorized access to cloud AI services. The disclosed technology may leverage the adaptive heuristics engine 606 that uses adaptive heuristics (616) to evolve based on detected anomalies, ensuring real-time learning. For example, the disclosed technology (e.g., the computer system 102) can implement unsupervised machine learning techniques to analyze deviations in normal AI behavior and define heuristics for future detection (618). In the example workflow 600 of FIG. 6A, the endpoint protection platform processing 604 may include logical processing of signals, such as raw signals. This processing can be performed with one or more different techniques, such as but not limited to LLMs. In some embodiments, such as with respect to the If/Then processing 652 of the workflow 650, the use of If/Then logical processing (620) can allow for processing multi-layer data for sophisticated pattern recognition beyond traditional AI detection techniques. The processing performed with respect to the workflow 650 can focus on anomalies in PCR and/or statistical methods (622). If/then decision trees (624) can also enable integration with other logic, such as logic of a SOAR platform (626). Leveraging if/then logical statements can make for accurate contextual decisions on shadow AI presence using cross-layer data. One or more LLMs and/or other AI models can be used to perform the disclosed technology and can be adjusted depending on system requirements and/or scale. For example, LLMs can be used to perform the if/then processing of 620, 622, 624, 626, and/or 650. This is merely an illustrative example and is not intended to be limiting.

Still referring to both the workflows 600 and 650 in FIGS. 6A and 6B, the workflow can provide for cross-layer correlation (628). Shadow AI can be detected by correlating detected anomalies across multiple layers that were monitored, thereby improving accuracy compared to traditional single-layer detection systems. The disclosed technology can leverage ensemble learning techniques, thereby combining anomaly detection across the hardware, middleware, and software layers to improve detection accuracy. Depending on the particular use case and/or enterprise infrastructure, one or more layers to monitor can be omitted and/or customized.

The workflow can also offer automated responses (630) and real-time mitigation (608) of detected anomalies or shadow AI, such as isolating containers (632) and/or terminating rogue processes (634), thereby minimizing or otherwise eliminating manual interventions. The disclosed technology can leverage a rules-based engine to automate the response workflows based on predefined security thresholds and/or patterns. The automated responses and actions may also vary based on the enterprise and/or infrastructure, such as isolating virtual machines instead of throttling hardware or invoking different levels of security escalation. Additionally, by dynamically updating signature libraries based on real-time activity, the disclosed workflow can provide for dynamic signature analysis and stay ahead of emerging shadow AI threats.

In some implementations, the workflow can include generating and returning information about the detected anomalies (e.g., identified deviations of detected AI operations). The information can include but is not limited to genealogy, or identification of what base model is a current AI model derived from. Other example information can include input identification, which can be based on a set of inputs within the current AI model that match signals sent. As another example, the information can include poisoning, or drift of model actions based on adversarial inputs, which can also be identified by signals during model execution. Yet another example of the information can include a type of activity (e.g., is the activity writing, deciding, classifying).

The disclosed technology can collect different types of data at different layers (e.g., hardware, middleware, software, network, correlation), which can be used to train one or more AI models to identify and detect anomalous behaviors that are indicative of shadow AI. This data collection and processing for AI training is illustrated in Table 5, reproduced below.

TABLE 5
Data Collection for AI Training

| Step | Data Collected | Data Labeling Process | Usage in Training |
|---|---|---|---|
| Hardware | CPU/GPU metrics, | AI-related spikes | Training AI to identify |
| | power consumption | tagged as abnormal | hardware usage patterns of |
| | logs | | unauthorized AI processes |
| Middleware | Container and | Flag unsanctioned | Training AI to correlate |
| | virtualization | execution of AI | suspicious middleware |
| | activities | frameworks | events with unauthorized AI |
| | | | execution |
| Software | AI model | Unusual execution | Train AI to recognize |
| | executions, script | labeled as shadow AI | unsanctioned software |
| | loads | | behavior linked to shadow |
| | | | AI operations |
| Network | Traffic to/from | AI-related traffic | AI models trained to detect |
| | cloud-based AI | patterns flagged | unexpected cloud |
| | services | | communication patterns |
| | | | indicative of shadow AI |
| Correlation | Combined across | Tagged based on multi- | Correlation engine trained to |
| | stack layers | layered anomaly | assess combined data and |
| | | correlation | identify shadow AI across |
| | | | stack |

The disclosed technology can incorporate one or more additional features to further enhance detection and mitigation of shadow AI. For example, the disclosed technology can implement behavioral models, which can be trained to predict AI activity based on user and/or application behavior, which can provide proactive detection capabilities. As another example, the disclosed technology can leverage edge computing to detect shadow AI at distributed locations beyond a central data center, thereby enhancing scalability of the disclosed technology. As yet another example, the disclosed technology can leverage federated learning to share anonymized detection patterns across multiple enterprises, thereby improving global detection of shadow AI. Similar to the techniques described in reference to FIGS. 2, 3, 4, and 5, the disclosed technology of FIGS. 6A and 6B can include compliance reporting and auditing features to ensure that detected AI processes meet regulatory requirements and standards. The disclosed technology can also incorporate API integration with platforms such as SOAR for seamless incident response. The disclosed technology can also develop and provide intuitive GUIs and dashboards for visualizing the detection of shadow AI in real-time, therefore providing improved operational insights for various stakeholders.

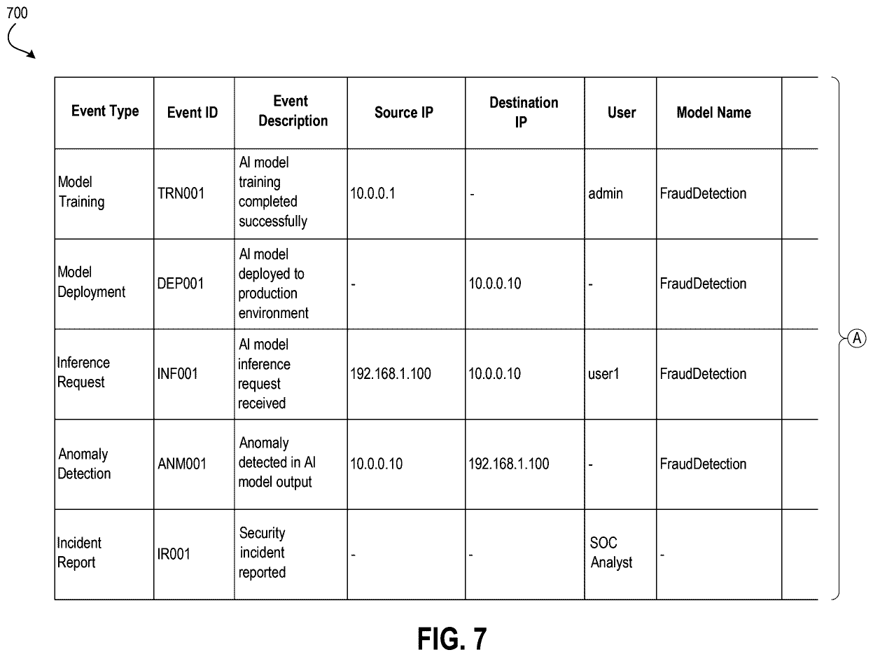

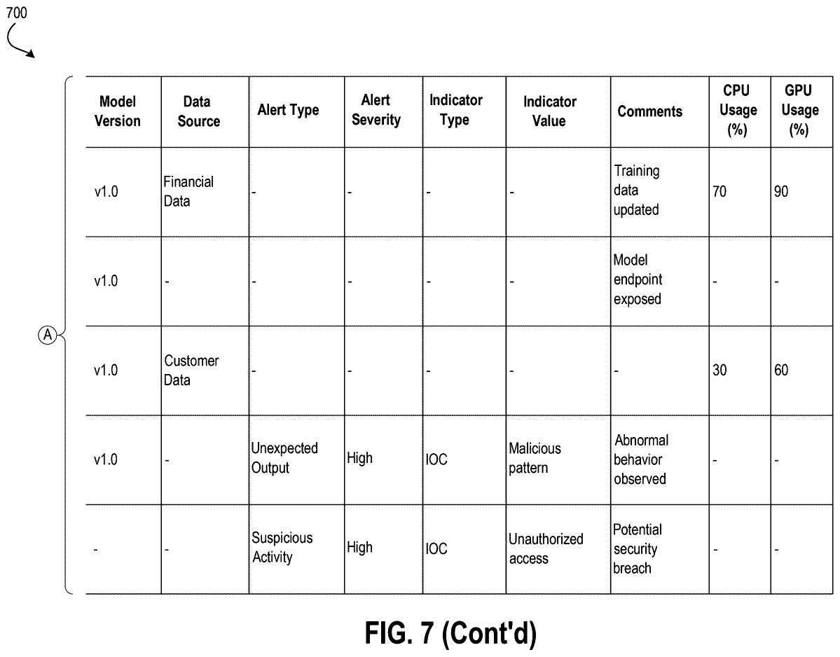

FIG. 7 illustrates an example table 700 for adapting AI system monitoring techniques at different layers using the disclosed technology to improve detection of AI use and abuse. As described in reference to at least FIGS. 6A and 6B, the disclosed technology can be used to detect and respond to unauthorized or shadow AI in an enterprise via multi-layer AI monitoring techniques. The disclosed technology can, therefore, monitor hardware, middleware, and software layers concurrently, and correlate anomalies across all layers, both automatically and in real-time or near real-time. As shown by the table 700 in FIG. 7, events throughout the entire MLOps, development, and deployment pipeline can be initially baselined and monitored to define events that are normal, or baseline signatures associated with an event type (e.g., see the first column in the table). Various different information or data can be captured, as described in reference to FIG. 1, including but not limited to source IP, destination IP, the physics of the device CPU, the physics of the device GPU, etc.

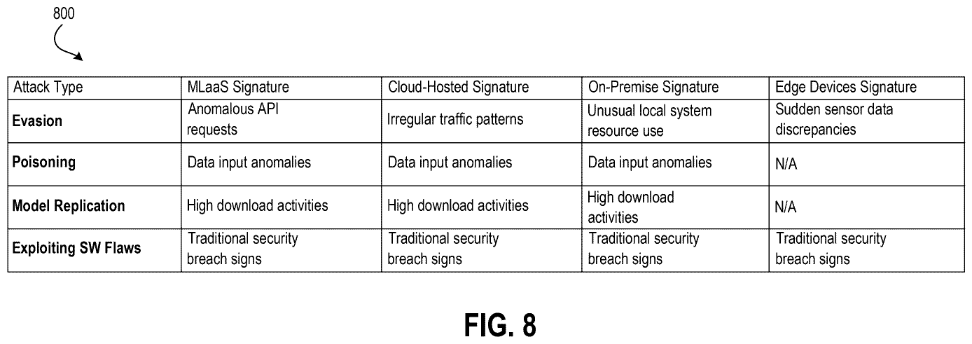

FIG. 8 is a table 800 of example signatures that may be analyzed for real-time threat detection. The computer system 102 described herein can include an adaptive heuristics engine (refer to FIGS. 6A and 6B), which can be configured to learn from cross-layer correlations and anomalies, and dynamically update signature analysis for real-time threat detection. Even if packets are spoofed at the IP level, CPU and GPU correlation techniques combined with cyber detections signatures can enable improved cross-layer correlations and anomalies, which are continuously updated. The table 800 of FIG. 8 demonstrates how some of those signatures may have only minor differences. Thus, stealthy exploits and attacks on AI may disguise themselves as crypto-mining or even normal activity.

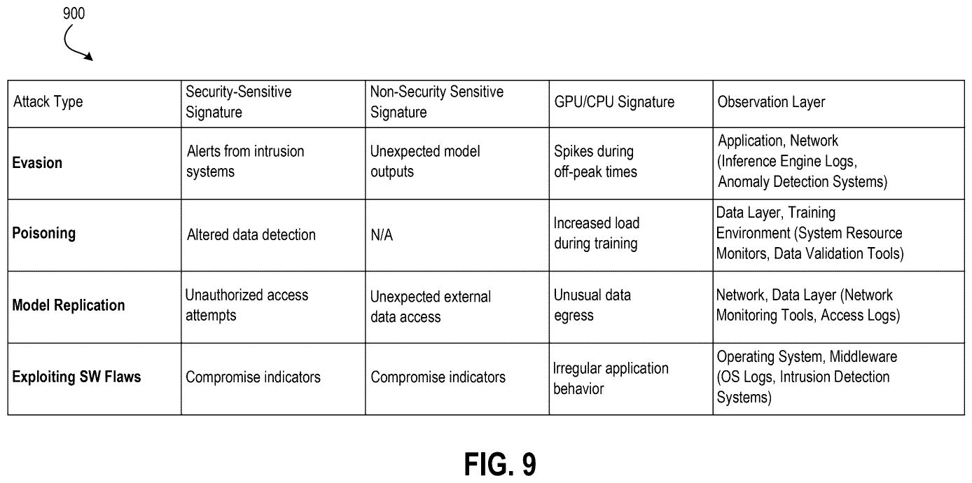

FIG. 9 is a table 900 of example signatures that may be observed, clustered, and correlated to improve AI anomaly detection techniques. As described in reference to at least FIGS. 6A and 6B, the computer system 102 may employ LLM-driven If/Then processing operations to enumerate anomalies and accurately identify and detect AI anomalies, such as shadow AI. The LLM-driven processing can focus on Principal Component Regression (PCR) enumerated anomalies and integrate with decision trees for one or more SOAR platforms, thereby enhancing logic processing with the LLM. In cybersecurity anomaly detection, PCR methods can reduce high-dimensional data into principal components, capturing patterns and behaviors in network traffic or user activity. By isolating principal components representing normal behavior, PCR can help identify outliers or anomalies indicative of potential security breaches or malicious activity. The disclosed detections include and focus on AI anomalies. For either one of the detections to be effective, there needs to be high levels of confidence and accuracy that signature or detection is in fact malicious and needs to be flagged. Applying statistical measures, such as PRC, can be improved through clustering and principal component analysis (PCA) to further reduce false positives. Accordingly, the table 900 of FIG. 9 shows how signatures at each layer can be observed and clustered and correlated to improve the accuracy of the detection results.

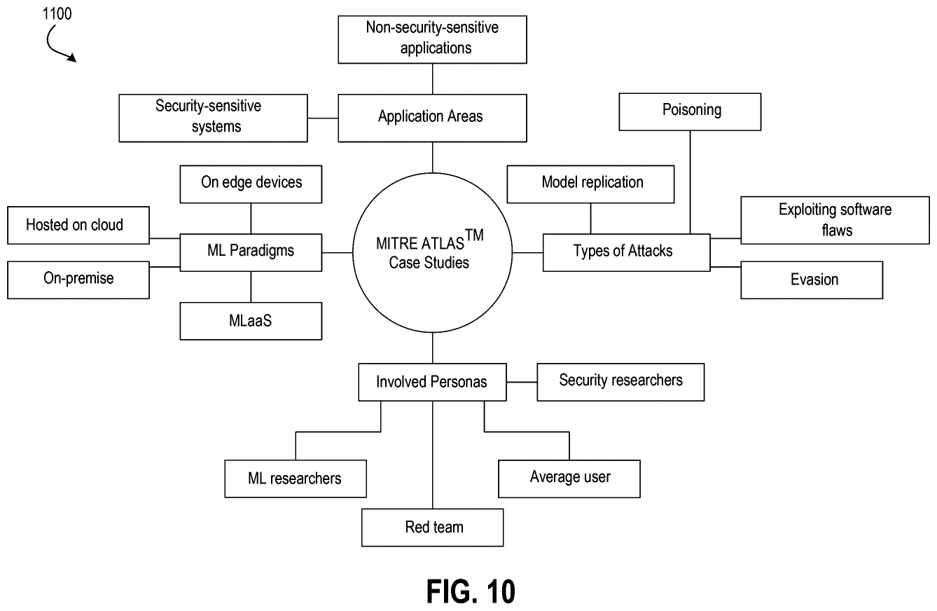

FIG. 10 illustrates an example diagram 1100 of coverage areas for integrating the disclosed technology with frameworks such as MITRE ATLAS. As described herein, continuous monitoring and adjustment can be performed with the disclosed technology to accurately detect and respond to everchanging anomalies such as unauthorized or shadow AI. For example, periodically, the disclosed technology can call an API that updates the latest TTPs and/or techniques that align with known frameworks, such as MITRE ATLAS. The prompts and scenarios for AI learning and testing can be updated accordingly. The example diagram 1100 of FIG. 10 illustrates some example coverage areas for such continuous monitoring and adjustment.

Similarly, the workflows shown and described in reference to at least FIG. 6 can be regularly or proactively tuned to address new threat vectors and emerging vulnerabilities. The following Table 6 illustrates examples of anomalous AI behavior, where and how it can be observed, and associated signatures.

TABLE 6
Anomalous AI Behaviors

| | | Patterns and | | | |
|---|---|---|---|---|---|
| | Indicators and | Correlations | | | |
| | Signatures of | for Detecting | | Adversarial | |
| | AI Running | and | | Behavior or | Potential |
| | Inside an | Enumerating | CPU and | Integrity | MITRE |
| Data Types | Enterprise | AI Presence | GPU Usage | Indicators | ATLAS TTP |
| Numerical | Significant | Anomalies in | Higher than | Adversarial | Data |
| | increase in | network | usual CPU | attacks | Manipulation |
| | computational | traffic | and GPU | leading to | (T1565), |
| | resource | associated | usage, | abnormal | Resource |
| | utilization, | with data | especially | fluctuations | Hijacking |
| | especially for | exchanges | during peak | in CPU or | (T1496) |
| | machine | between AI | hours or | GPU usage, | |
| | learning | training and | specific tasks | possibly | |
| | frameworks | inference | related to | indicating | |
| | such as | systems and | model | attempts to | |
| | TensorFlow or | external data | training or | overload or | |
| | PyTorch. | sources or | inference. | disrupt AI | |
| | | cloud | | systems. | |
| | | platforms. | | | |
| Categorical | Elevated usage | Unusual | Fluctuations | Anomalies in | Model |
| | of specialized | patterns in | in CPU and | model | Poisoning |
| | hardware | system logs | GPU usage | performance | (T1566), |
| | accelerators | related to the | corresponding | metrics or | Data |
| | like GPUs or | deployment | to the | outputs, such | Obfuscation |
| | TPUs, | and execution | initiation and | as sudden | (T1001) |
| | indicative of AI | of AI models, | completion of | drops in | |
| | model training | such as | AI-related | accuracy or | |
| | or inference | frequent | tasks, with | unexpected | |
| | tasks. | access to | GPUs often | changes in | |
| | | model files | showing more | predictions, | |
| | | and libraries. | pronounced | suggesting | |
| | | | spikes during | potential | |
| | | | intensive | adversarial | |
| | | | deep learning | manipulation | |
| | | | computations. | of the AI | |
| | | | | model. | |
| Textual | Adoption of | Correlation | Sudden | Suspicious | Data |
| | AI-driven | between | increases in | patterns in | Obfuscation |
| | applications | spikes in AI- | CPU and | data input or | (T1001), |
| | and platforms | related | GPU usage | feature | Input |
| | for various | software | coinciding | distributions, | Capture |
| | business | installation or | with the | indicating | (T1056) |
| | processes, such | updates and | rollout or | potential | |
| | as customer | corresponding | scaling up of | adversarial | |
| | service | changes in | AI-powered | inputs aimed | |
| | chatbots or | operational | applications | at deceiving | |
| | predictive | workflows or | and platforms | the AI model. | |
| | analytics tools. | business | within the | | |
| | | outcomes. | enterprise. | | |
| Time- | Increased | Abnormalities | Gradual shifts | Changes in | Model |
| Series | utilization of | in user access | in CPU and | model | Poisoning |
| | AI-centric | patterns and | GPU usage | behavior over | (T1566), |
| | development | permissions, | patterns | time, such as | Exfiltration |
| | tools and | suggesting | reflecting | deviations | Over C2 |
| | frameworks, | adjustments | ongoing | from | Channel |
| | such as Jupyter | made to | development | expected | (T1041) |
| | Notebooks or | accommodate | and testing | learning | |
| | TensorFlow | AI-related | activities | curves or | |
| | Serving. | tasks or | associated | sudden shifts | |
| | | initiatives. | with AI- | in decision | |
| | | | centric tools | boundaries, | |
| | | | and | which may | |
| | | | frameworks. | indicate | |
| | | | | adversarial | |
| | | | | attacks or | |
| | | | | model drift. | |
| Boolean | Growth in the | Changes in | Long-term | Malicious | Model |
| | number of AI- | data storage | trends in CPU | modifications | Poisoning |
| | related job | and | and GPU | to AI training | (T1566), |
| | postings, | processing | usage | data or model | Exploit |
| | training | infrastructure | mirroring the | parameters, | Public- |
| | programs, and | to | organization's | leading to | Facing |
| | internal | accommodate | investment in | unexpected | Application |
| | initiatives | large-scale | AI talent and | biases or | (T1190) |
| | focused on AI | datasets | infrastructure, | vulnerabilities | |
| | skill | required for | with | in the AI | |
| | development | AI training | sustained | system. | |
| | within the | and inference | increases | | |
| | organization. | tasks. | indicating | | |
| | | | continued AI | | |
| | | | adoption and | | |
| | | | expansion. | | |
| | Implementation | Identification | CPU and | Anomalous | Software |
| | of AI | of AI-specific | GPU usage | behavior in | Manipulation |
| | governance | metadata or | fluctuations | AI model | (T1505), |
| | frameworks | tags | aligned with | outputs or | Data |
| | and policies | associated | periods of AI | decision- | Obfuscation |
| | aimed at | with data | governance | making | (T1001) |
| | ensuring | sources, | policy | processes, | |
| | ethical AI | indicating | enforcement, | potentially | |
| | usage, | their use in | such as | indicating | |
| | responsible | AI model | increased | attempts to | |
| | data handling, | training or | resource | manipulate or | |
| | and compliance | validation | allocation for | deceive the | |
| | with regulatory | processes. | compliance | AI system for | |
| | standards. | | audits or | malicious | |
| | | | model | purposes. | |
| | | | explainability | | |
| | | | (WAI) | | |
| | | | assessments. | | |

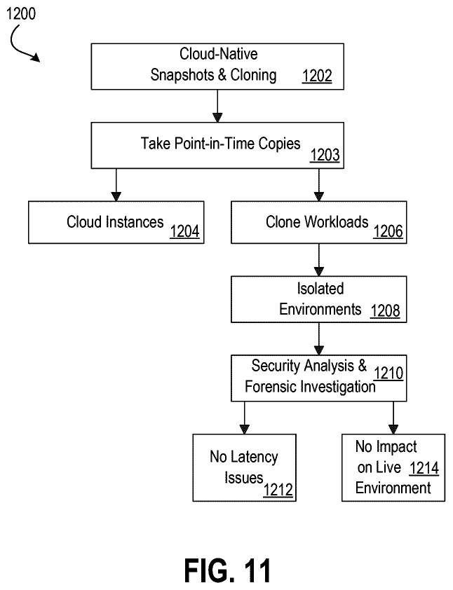

FIG. 11 is a flowchart of a process 1200 for detecting and managing shadow AI threats by inspecting cloned workloads in a secure environment. The process 1200 of FIG. 11 can be performed by the computer system 102 described herein. In some implementations, the process 1200 of FIG. 11 can be performed by a shadow AI detection module, which can be part of the computer system 102 or separate from the computer system 102.

The process 1200 of FIG. 11 can be performed to generate cloned copies of workloads from AI systems that are cloud-based, inspect or analyze these workloads for AI-related threats, and store the findings in a database for ongoing analysis and threat correlation. This process 1200 can therefore be used to inspect workloads for AI-related threats and vulnerabilities, leveraging signature-based, heuristic-based, and other detection techniques described herein to ensure the integrity of cloud-based AI systems. The techniques described in reference to FIG. 11 are merely illustrative examples and not intended to be limited. Thus, the disclosed techniques, although described with respect to the evaluation, detection, and response of cloud-hosted AI solutions, can also be extended to apply to other cloud-native IT applications.

For example, the process 1200 of FIG. 11 allows for cloud-native snapshots and cloning in block 1202, which takes points-in-time copies (block 1203) of cloud instances (block 1204). These snapshots can then be used to clone workloads (block 1206) in isolated environments (block 1208) for security analysis and forensic investigation (block 1210) without causing latency issues (block 1212) or impacting the live environment (block 1214). The process 1200 of FIG. 11 also allows for traffic monitoring for inspection, thereby enabling more real-time monitoring of network traffic. This mirrored traffic can be redirected to a security tool for deep packet inspection (DPI) and anomaly detection, which can help identify unauthorized AI instances and malicious activities in the network layer. The process 1200 of FIG. 11 also allows for continuous backup and inspection. In other words, the disclosed technology can be used to implement regular, automated backups using cloud-native tools and mirror these backups to scan for potential anomalies, indicators of compromise (IoCs), or signatures of unauthorized AI deployments using security solutions such as anti-malware scanners, threat-hunting tools, and/or AI-based behavioral analysis engines.

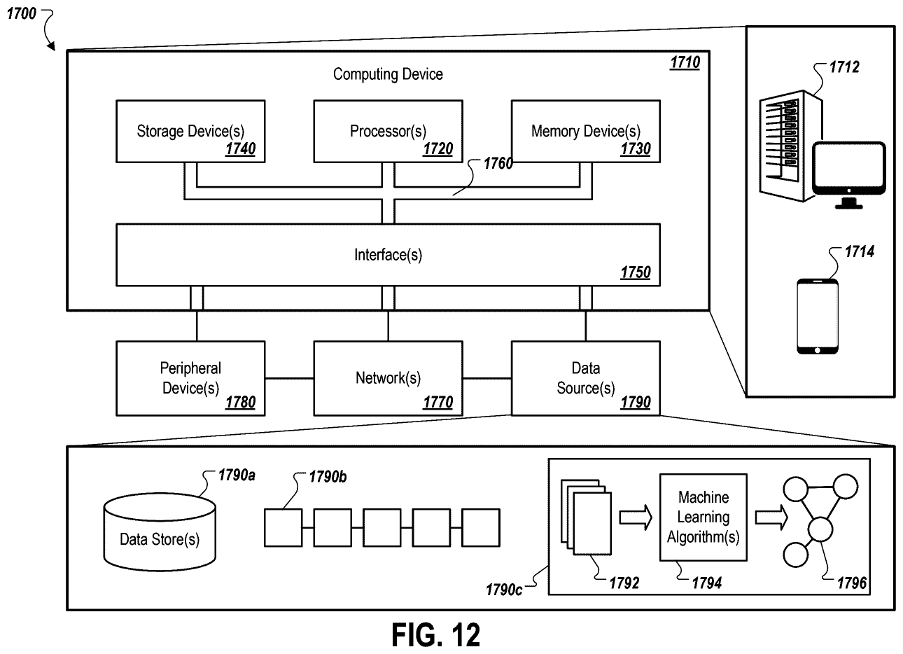

FIG. 12 is a schematic diagram that shows an example of a computing system 1700 that can be used to implement the techniques described herein. The computing system 1700 includes one or more computing devices (e.g., computing device 1710), which can be in wired and/or wireless communication with various peripheral device(s) 1780, data source(s) 1790, and/or other computing devices (e.g., over network(s) 1770). The computing device 1710 can represent various forms of stationary computers 1712 (e.g., workstations, kiosks, servers, mainframes, edge computing devices, quantum computers, etc.) and mobile computers 1714 (e.g., laptops, tablets, mobile phones, personal digital assistants, wearable devices, etc.). In some implementations, the computing device 1710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1710, and an entire system can be made up of multiple devices communicating with each other. For example, the computing device 1710 can be part of a computing system that includes a network of computing devices, such as a cloud-based computing system, a computing system in an internal network, or a computing system in another sort of shared network. Processors of the computing device (1710) and other computing devices of a computing system can be optimized for different types of operations, secure computing tasks, etc. The components shown herein, and their functions, are meant to be examples, and are not meant to limit implementations of the technology described and/or claimed in this document.

The computing device 1710 includes processor(s) 1720, memory device(s) 1730, storage device(s) 1740, and interface(s) 1750. Each of the processor(s) 1720, the memory device(s) 1730, the storage device(s) 1740, and the interface(s) 1750 are interconnected using a system bus 1760. The processor(s) 1720 are capable of processing instructions for execution within the computing device 1710, and can include one or more single-threaded and/or multi-threaded processors. The processor(s) 1720 are capable of processing instructions stored in the memory device(s) 1730 and/or on the storage device(s) 1740. The memory device(s) 1730 can store data within the computing device 1710, and can include one or more computer-readable media, volatile memory units, and/or non-volatile memory units. The storage device(s) 1740 can provide mass storage for the computing device 1710, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1750 can include various communications interfaces (e.g., USB, Near-Field Communication (NFC), Bluetooth, WiFi, Ethernet, wireless Ethernet, etc.) that can be coupled to the network(s) 1770, peripheral device(s) 1780, and/or data source(s) 1790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1750 can include a control interface that receives commands from an input device (e.g., operated by a user) and converts the commands for submission to the processors 1720. The interface(s) 1750 can include a display interface that includes circuitry for driving a display to present visual information to a user. The interface(s) 1750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1710 can communicate with the peripheral device(s) 1780, the data source(s) 1790, and/or other computing devices over the network(s) 1770. In some implementations, the computing device 1710 can directly communicate with the peripheral device(s) 1780, the data source(s), and/or other computing devices.

The peripheral device(s) 1780 can provide input/output operations for the computing device 1710. Input devices (e.g., keyboards, pointing devices, touchscreens, microphones, cameras, scanners, sensors, etc.) can provide input to the computing device 1710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1790 can provide data for use by the computing device 1710, and/or can maintain data that has been generated by the computing device 1710 and/or other devices (e.g., data collected from sensor devices, data aggregated from various different data repositories, etc.). In some implementations, one or more data sources can be hosted by the computing device 1710 (e.g., using the storage device(s) 1740). In some implementations, one or more data sources can be hosted by a different computing device. Data can be provided by the data source(s) 1790 in response to a request for data from the computing device 1710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1790a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1790c. The machine learning system(s) 1790c, for example, can be used to analyze data from various sources (e.g., data provided by the computing device 1710, data from the data store(s) 1790a, data from the blockchain(s) 1790b, and/or data from other data sources), to identify patterns in the data, and to draw inferences from the data patterns. In general, training data 1792 can be provided to one or more machine learning algorithms 1794, and the machine learning algorithm(s) can generate a machine learning model 1796. Execution of the machine learning algorithm(s) can be performed by the computing device 1710, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for monitoring artificial intelligence (AI) and responding to cybersecurity threats in a computing environment, the method comprising:
monitoring, in real-time, computational resources and network traffic in a computing environment to identify potential AI operations;
detecting, using signatures, the potential AI operations;
determining AI-specific behavioral patterns based on applying heuristics to the detected AI operations;
identifying deviations of the detected AI operations from normal operational patterns using deep learning anomaly detection techniques; and
returning information about the identified deviations of the detected AI operations.

2. The method of claim 1, wherein the computational resources comprise at least one of CPU usage or GPU usage.

3. The method of claim 1, wherein the information about the identified deviations of the detected AI operations comprises at least one of: (i) genealogy, (ii) input identification, (iii) poisoning, or (iv) a type of activity.

4. The method of claim 1, wherein the method further comprises augmenting the monitored computational resources and network traffic to reduce false positives and predict or mitigate new threats.

5. The method of claim 1, wherein the method further comprises generating fingerprints for trained machine learning models in an AI environment, and
wherein identifying the deviations of the detected AI operations is further based on using the fingerprints to monitor usage, versioning, and instances of the respective trained machine learning models in the AI environment.

6. The method of claim 1, wherein returning the information comprises generating an automated response to the identified deviations of the detected AI operations.

7. The method of claim 6, wherein the automated response comprises retraining a machine learning model associated with the detected AI operations.

8. The method of claim 6, wherein the automated response comprises at least one of (i) updating a configuration in an AI environment of the detected AI operations or (ii) adjusting access controls for one or more uses in the AI environment of the detected AI operations.

9. The method of claim 1, wherein monitoring the computational resources and the network traffic comprises:
generating cloned copies of workloads from a cloud computing environment; and
analyzing the cloned copies of workloads to identifying the deviations of the detected AI operations.

10. The method of claim 1, wherein the method further comprises:
concurrently monitoring hardware, middleware, and software layers of an AI system to identify potential AI operations;
correlating the identified potential AI operations across the layers;
performing if/then processing of the identified AI operations to identify anomalies in the identified AI operations; and
returning information about the identified anomalies.

11. A method for detecting and mitigating threats in an artificial intelligence (AI) environment, the method comprising:
generating cloned copies of workloads from a cloud computing environment;
detecting AI operations based on the cloned copies of workloads;
identifying deviations of the detected AI operations from normal operational patterns using deep learning anomaly detection techniques; and
returning information about the identified deviations of the detected AI operations.

12. The method of claim 11, wherein the identified deviations of the detected AI operations comprise shadow AI instances in the cloud computing environment.

13. The method of claim 11, wherein identifying the deviations comprises detecting shadow AI instances in the cloud computing environment based on signatures or heuristics.

14. The method of claim 13, wherein the signatures comprise unauthorized model signatures and API pattern signatures.

15. The method of claim 13, wherein the heuristics comprise abnormal data access and resource spikes.

16. A method for detecting and mitigating threats in an artificial intelligence (AI) environment, the method comprising:
concurrently monitoring hardware, middleware, and software layers of an AI system to identify potential AI operations;
correlating the identified potential AI operations across the layers;
performing if/then processing of the identified AI operations to identify anomalies in the identified AI operations; and
returning information about the identified anomalies.

17. The method of claim 16, wherein the method further comprises dynamically updating signature analysis based on the correlating for real-time threat detection.

18. The method of claim 16, wherein the if/then processing is performed based on applying a large language model (LLM) to the identified AI operations.

19. The method of claim 16, wherein returning the information about the identified anomalies comprises at least one of: (i) performing automated actions to isolate containers in the AI system or (ii) performing automated actions to terminate rogue processes in the AI system.

20. The method of claim 16, wherein concurrently monitoring hardware, middleware, and software layers of an AI system comprises applying an AI model to identify hardware usage patterns of unauthorized AI processes in the hardware layer.

21. The method of claim 16, wherein concurrently monitoring hardware, middleware, and software layers of an AI system comprises applying an AI model to correlate suspicious middleware events with unauthorized AI execution in the middleware layer.

22. The method of claim 16, wherein concurrently monitoring hardware, middleware, and software layers of an AI system comprises applying an AI model to recognized unsanctioned software behavior linked to shadow AI operations in the software layer.
